(19) United States
(12) Patent Application Publication
(10) Pub. No.: US 2010/0242789 A1
(43) Pub. Date: Sep. 30, 2010

(54) METHOD FOR PRODUCING WATER-REPELLENT TREATED ALUMINUM PIGMENT DISPERSION, WATER-REPELLENT TREATED ALUMINUM PIGMENT, AND AQUEOUS INK COMPOSITION CONTAINING THE SAME

(75) Inventors: Tsuyoshi SANO, Shiojiri-shi (JP); Takayoshi Kagata, Shiojiri-shi (JP); Suzuki Kazuko, Kyoto-shi (JP); Nakamoto Junko, Osaka-shi (JP); Shiori Masuda, San Jose, CA (US)

Correspondence Address: LADAS & PARRY, 26 West 61st Street, New York, NY, 10023, US

(73) Assignee: SEIKO EPSON CORPORATION

(21) Appl. No.: 12/731,206

(22) Filed: Mar. 25, 2010

(30) Foreign Application Priority Data
Mar. 26, 2009 (JP) 2009-075526

(51) Int. Cl. C09D 11/00; C09C 1/62

(52) U.S. Cl. 106/31.9; 106/404

(57) ABSTRACT

A method for producing water-repellent treated aluminum pigment dispersion includes (a) adding a glycidyl group-containing compound represented by the following formula (1) to an aluminum pigment dispersion in which an aluminum pigment is dispersed in an organic solvent for reacting a hydroxyl group present on the surface of the aluminum pigment with the glycidyl group-containing compound represented by the formula (1) to form a covering layer on the surface of the aluminum pigment:

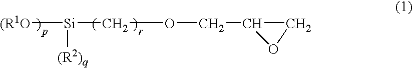

(in the formula, p represents an integer of 1 to 3, q represents an integer that satisfies a relation of p+q=3, r is an integer of 2 to 10, and R¹ and R² independently represent an alkyl group having 1 to 4 carbon atoms).

### BACKGROUND

1. Technical Field

The present invention relates to a method for producing water-repellent treated aluminum pigment dispersion, water-repellent treated aluminum pigment, and an aqueous ink composition containing the pigment.

2. Related Art

As a method for forming a coating having metallic gloss on a printed matter, it has been employed, for example, foil stamping printing using a printing ink including a gold or silver powder made from, for example, brass or aluminum fine particles or metallic foil, or a thermal transfer system using metallic foil.

Recently, there have been many applications of ink jet technology to printing. Metallic printing is one of such applications, and ink having metallic gloss has been being developed. For example, JP-A-2008-174712 discloses an aluminum pigment dispersion containing an organic solvent such as alkylene glycol as a base material and discloses a non-aqueous ink composition containing the dispersion.

At the same time, it is the current status that aqueous ink compositions are required to be developed, rather than non-aqueous ink composition containing organic solvents as base materials, from the viewpoints of global environment and safety for the human body.

However, an aluminum pigment has a problem that the pigment dispersed in water reacts with water to generate hydrogen gas and also form alumina, resulting in whitening to impair the metallic gloss. Therefore, the base material of an ink composition containing an aluminum pigment must be an organic solvent hardly containing water.

### SUMMARY

An advantage of some aspects of the invention is to provide a method for producing water-repellent treated aluminum pigment dispersion that is prevented from being whitened when it is blended with an aqueous paint or an aqueous ink and is excellent in water dispersibility and metallic gloss.

The method for producing water-repellent treated aluminum pigment dispersion of the invention includes

(a) adding a glycidyl group-containing compound represented by the following formula (1) to an aluminum pigment dispersion in which an aluminum pigment is dispersed in an organic solvent for reacting a hydroxyl group present on the surface of the aluminum pigment with the glycidyl group-containing compound represented by the formula (1) to form a covering layer on the surface of the aluminum pigment:

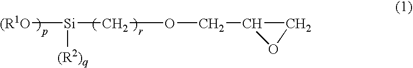

(in the formula, p represents an integer of 1 to 3, q represents an integer that satisfies a relation of p+q=3, r is an integer of 2 to 10, and R¹ and R² independently represent an alkyl group having 1 to 4 carbon atoms).

The method for producing water-repellent treated aluminum pigment dispersion according to the invention may further include, after the step (a), a step (b) densifying the covering layer.

The method for producing water-repellent treated aluminum pigment dispersion according to the invention may further include, after the step (a), a step (c) adding an acid for opening the glycidyl group.

The method for producing water-repellent treated aluminum pigment dispersion according to the invention may further include, after the step (a), a step (d) subjecting the glycidyl group to a reaction with alkoxysilane having an amino group and then hydrolyzing the alkoxyl group of the alkoxysilane having an amino group to form a silanol group.

The method for producing water-repellent treated aluminum pigment dispersion according to the invention may further include, after the above-mentioned steps, a step (e) adding alkoxyalkylsilane for a reaction of the hydroxyl group remaining on the surface of the aluminum pigment with the alkoxyalkylsilane to form a covering layer on the surface of the aluminum pigment.

In the method for producing water-repellent treated aluminum pigment dispersion according to the invention, the alkoxyalkylsilane is trimethoxymethylsilane.

The method for producing water-repellent treated aluminum pigment dispersion according to the invention may further include, after the above-mentioned steps, a step (f) adding a surfactant.

In the method for producing water-repellent treated aluminum pigment dispersion according to the invention, the surfactant is an anionic surfactant.

The method for producing water-repellent treated aluminum pigment dispersion according to the invention may further include, after the above-mentioned steps, a step (g) removing at least part of the organic solvent and then adding an aqueous solution of a phosphorous anionic surfactant for solvent substitution.

In the method for producing water-repellent treated aluminum pigment dispersion according to the invention, the aluminum pigment may be a plate-like particle having an average thickness of 5 to 30 nm and a 50% mean particle diameter of 0.5 to 3 μm.

In the method for producing water-repellent treated aluminum pigment dispersion according to the invention, the covering layer may have a thickness of 0.5 to 10 nm.

In the method for producing water-repellent treated aluminum pigment dispersion according to the invention, the organic solvent is diethylene glycol diethyl ether or triethylene glycol monobutyl ether.

The aqueous ink composition according to the invention contains an aluminum pigment dispersion produced by the above-described method for producing water-repellent treated aluminum pigment dispersion.

The water-repellent treated aluminum pigment according to the invention is a water-repellent treated aluminum pigment in which a covering layer containing at least Si is formed on the surface of an aluminum pigment having an average thickness of 5 to 30 nm and a 50% mean particle diameter of 0.5 to 3 wherein

the aluminum pigment surface coverage ratio by the covering layer is 20 to 90% when it is calculated from the composition ratios of C, O, Al, and Si that are detected by XPS at an incident angle of 30°.

In the water-repellent treated aluminum pigment according to the invention, the covering layer has a thickness of 0.5 to 10 nm.

### DESCRIPTION OF EXEMPLARY EMBODIMENTS

Preferred embodiments of the invention will be described in detail below, but the invention is not limited thereto.

### 1. Method for Producing Water-Repellent Treated Aluminum Pigment Dispersion

A method for producing water-repellent treated aluminum pigment dispersion according to an embodiment of the invention includes

(a) adding a glycidyl group-containing compound represented by the following formula (1) to an aluminum pigment dispersion in which an aluminum pigment is dispersed in an organic solvent for a reaction of a hydroxyl group present on the surface of the aluminum pigment with the glycidyl group-containing compound represented by the formula (1) to form a covering layer on the surface of the aluminum pigment (hereinafter also simply referred to as “step (a)”):

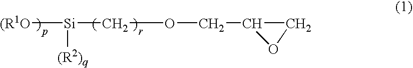

(in the formula, p represents an integer of 1 to 3, q represents an integer that satisfies a relation of p+q=3, r is an integer of 2 to 10, and R¹ and R² independently represent an alkyl group having 1 to 4 carbon atoms).

An example of the method for producing water-repellent treated aluminum pigment dispersion according to the embodiment will be described below.

1.1 Step (a)

First, an aluminum pigment is dispersed in an organic solvent by the following steps (1) and (2) to prepare an aluminum pigment dispersion.

(1) A composite pigment base substrate having a structure in which a peeling resin layer and an aluminum or aluminum alloy layer (hereinafter simply referred to as “aluminum layer”) are sequentially laminated on a sheet-like base material is prepared.

The sheet-like base material is not particularly limited, and examples thereof include polyester films such as polytetrafluoroethylene, polyethylene, polypropylene, and polyethylene terephthalate; polyamide films such as Nylon 66 and Nylon 6; and mold-releasing films such as polycarbonate films, triacetate films, and polyimide films. Among them, polyethylene terephthalate and copolymers thereof are preferred.

The thickness of the sheet-like base material is not particularly limited, but is preferably 10 to 150 μm. A thickness of 10 μm or more does not cause problems in handling during a processing step or the like, and a thickness of 150 μl or less imparts high flexibility and does not cause problems in, for example, rolling and peeling.

The peeling resin layer is an undercoat layer for the aluminum layer and serves as a peelable layer for improving the peelability from the sheet-like base material. Preferred examples of the resin used for the peeling resin layer include polyvinyl alcohol, polyvinyl butyral, polyethylene glycol, polyacrylic acid, polyacrylamide, cellulose derivatives, acrylic acid polymers, and denatured nylon resins.

The peeling resin layer can be formed by applying a solution of a mixture of one or more of the above-mentioned resins to a sheet-like base material, followed by drying. The application solution may contain an additive such as a viscosity modifier.

The application of the peeling resin layer can be performed by a known technology such as gravure coating, roll coating, blade coating, extrusion coating, dip coating, or spin coating that is usually used. After the application and drying, if necessary, the surface may be smoothed by calender treatment.

The thickness of the peeling resin layer is not particularly limited, but is preferably 0.5 to 50 μm and more preferably 1 to 10 μm. A thickness smaller than 0.5 μm is an insufficient amount as a dispersion resin. A thickness larger than 50 μm tends to cause peeling at the interface with the pigment layer when rolled.

The aluminum layer is preferably deposited by vacuum deposition, ion plating, or sputtering.

The aluminum layer may be disposed between protection layers as described in JP-A-2005-68250. Examples of the protection layers include silicon oxide layers and resin protection layers.

The silicon oxide layer is not particularly limited as long as the layer contains silicon oxide, but is preferably formed of an silicon alkoxide such as tetraalkoxysilane or a polymer thereof by a sol-gel method. The silicon oxide layer is formed as a coating film by applying an alcohol solution dissolving silicon alkoxide or a polymer thereof, followed by heating and baking.

The protection resin layer is not particularly limited as long as the layer is made of a resin not being dissolved in a dispersion medium. Examples of the resin include polyvinyl alcohol, polyethylene glycol, polyacrylic acid, polyacrylamide, and cellulose derivatives. Among them, the layer is preferably formed of polyvinyl alcohol or a cellulose derivative.

The protection resin layer can be formed by applying an aqueous solution of a mixture of one or more of the above-mentioned resins, followed by drying. The application solution may contain an additive such as a viscosity modifier. The application of silicon oxide and a resin can be performed by the same method as in the application of the peeling resin layer.

The thickness of the protection layer is not particularly limited, but is preferably in the range of from 50 to 150 nm. A thickness of smaller than 50 nm causes insufficient mechanical strength, but a thickness of larger than 150 nm causes difficulties in pulverization and dispersion due to too high strength and further may cause peeling at the interface with the aluminum layer.

Furthermore, a color material layer may be provided between the “protection layer” and the “aluminum layer”, as described in JP-A-2005-68251.

The color material layer is provided for obtaining an intended colored composite pigment and is not particularly limited as long as it can contain a color material that can impart intended tone and hue to the aluminum pigment used in the embodiment, in addition to the metallic gloss, brilliance, and background-covering ability. The color material used in the color material layer may be either a dye or a pigment, and known dyes and pigments can be arbitrarily used.

The “pigment” used in the color material layer in this case refers to those defined in the field of general engineering, such as natural pigments, synthetic organic pigments, and synthetic inorganic pigments.

The formation method of the color material layer is not particularly limited, but is preferably formed by coating. When the color material used in the color material layer is a pigment, it is preferable that the layer further contain a color material-dispersing resin. The color material layer containing a color material-dispersing resin is preferably formed as a thin resin film by dispersing or dissolving the pigment, the color material-dispersing resin, and, according to need, other additives in a solvent, forming a uniform liquid film of the resulting solution by spin coating, and drying it. In addition, in the production of the composite pigment base substrate, it is preferable from the standpoint of work efficiency that both the color material layer and the protection layer be formed by coating.

The composite pigment base substrate may have a layer configuration having a plurality of structures in which the peeling resin layer and the aluminum layer are sequentially laminated. In such a case, the total thickness of the laminar structure composed of a plurality of aluminum layers, that is, the thickness of (aluminum layer/peeling resin layer/aluminum layer) or (peeling resin layer/aluminum layer), excluding the sheet-like base material and the peeling resin layer directly disposed thereon, is preferably 5000 nm or less. A thickness not larger than 5000 nm hardly causes cracking and peeling in the composite pigment base substrate even when it is rolled and thus provides excellent storage properties. In addition, after being formed into a pigment, the excellent metallic gloss is still preferably maintained. Furthermore, the resin layer and the aluminum layer may be laminated alternately on each of both surfaces of the sheet-like base material, but the configuration is not limited to these structures.

(2) Then, an aluminum pigment dispersion containing coarse particles is prepared by peeling the aluminum layer from the composite pigment base substrate at the interface between the sheet-like base material and the peeling resin layer of the composite pigment base substrate in an organic solvent, and pulverizing or microparticulating the aluminum layer. Furthermore, the resulting aluminum pigment dispersion is subjected to filtration for removing the coarse particles to obtain an aluminum pigment dispersion containing plate-like aluminum particles.

The organic solvent may be one that does not impair the dispersion stability of the aluminum pigment and the reactivity with the glycidyl group-containing compound represented by the formula (1) and is preferably a polar organic solvent. Examples of the polar organic solvent include alcohols (for example, methyl alcohol, ethyl alcohol, propyl alcohol, butyl alcohol, isopropyl alcohol, and fluorinated alcohols), ketones (for example, acetone, methyl ethyl ketone, and cyclohexanone), carboxylic acid esters (for example, methyl acetate, ethyl acetate, propyl acetate, butyl acetate, methyl propionate, and ethyl propionate), and ethers (for example, diethyl ether, dipropyl ether, tetrahydrofuran, and dioxane).

Among the polar organic solvents mentioned above, alkylene glycol monoether and alkylene glycol diether that are liquids at ordinary temperature and pressure are more preferred.

Examples of the alkylene glycol monoether include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, and dipropylene glycol monoethyl ether.

Examples of the alkylene glycol diether include ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Among them, from the viewpoint of being excellent in dispersion stability of the aluminum pigment, triethylene glycol monobutyl ether and diethylene glycol diethyl ether are more preferred. Furthermore, from the viewpoints of gloss and water repellency of the aluminum pigment, diethylene glycol diethyl ether is particularly preferred.

The peeling method from the sheet-like base material is not particularly limited. Preferred is a method in which the composite pigment base substrate is immersed in a liquid for peeling or a method in which the composite pigment base substrate is immersed in a liquid and is simultaneously sonicated for performing peeling and pulverization of the peeled composite pigment at the same time.

In the thus obtained aluminum pigment composed of plate-like particles, the peeling resin layer functions as protective colloid, and thereby a stable dispersion can be obtained by only performing dispersion treatment in a solvent. In an ink composition containing the aluminum pigment, the resin derived from the peeling resin layer also can have a function of providing adhesion against a recording medium.

It is preferable that the aluminum pigment in the aluminum pigment dispersion prepared through the process described above have a plate-like particle shape from the viewpoints of providing satisfactory water repellency and metallic gloss.

Here, the term “plate-like particle” refers a particle having an approximately flat surface (X-Y plane) and an approximately uniform thickness (Z), when the major axis and the minor axis of the flat surface and the thickness of the aluminum particle are denoted as X, Y, and Z, respectively. More specifically, the particle satisfies the requirements that the 50% mean particle diameter R50 (hereinafter also simply referred to as “R50”) based on circle-equivalent diameters determined from the approximately flat surface (X-Y plane) areas of the aluminum particles is from 0.5 to 3 μm and the thickness (Z) is from 5 to 30 nm.

The term “circle-equivalent diameter” refers to the diameter of a circle that has the same projected area as that of the approximately flat surface (X-Y plane) of the aluminum particle. For example, when the approximately flat surface (X-Y plane) of the aluminum particle is a polygon, the diameter of a circle that is obtained by converting the projected image of the polygon so as to have the same area as that of the polygon is the circle-equivalent diameter of the aluminum particle.

The 50% mean particle diameter R50 based on circle-equivalent diameters determined from the approximately flat surface (X-Y plane) areas of the plate-like particles is preferably 0.5 to 3 μm and more preferably 0.75 to 2 from the viewpoints of satisfactory metallic gloss and printing stability. When the R50 is smaller than 0.5 μm, the metallic gloss may be insufficient. On the other hand, when the R50 is larger than 3 μm, the printing stability may be decreased.

The maximum particle diameter based on circle-equivalent diameters determined from the approximately flat surface (X-Y plane) areas of the plate-like particles is preferably 10 μm or less. By regulating the maximum particle to 10 μm or less, clogging of the plate-like particles in, for example, the nozzle of an ink jet recording apparatus and the foreign matter-removing filter disposed in an ink channel can be prevented.

The major axis X, the minor axis Y, and the circle-equivalent diameter of the flat surface of the plate-like particle can be measured with a particle image analyzer. Examples of the particle image analyzer include flow particle image analyzers, FPIA-2100, FPIA-3000, and FPIA-3000S (these are manufactured by Sysmex Corp.).

The particle size distribution (CV value) of the plate-like particles can be determined by the following equation (2):

CV value={(standard deviation of particle distribution)/(average particle diameter)}×100 (2).

Here, the resulting CV value is preferably 60 or less, more preferably 50 or less, and most preferably 40 or less. By collecting particles having a CV value of 60 or less, an advantageous effect, excellent printing stability, can be achieved.

The thickness (Z) is preferably 5 to 30 nm and more preferably 10 to 25 nm from the viewpoint of ensuring metallic gloss. When the thickness (Z) is smaller than 5 nm, the metallic gloss tends to be decreased when the covering layer is formed on the surface of the aluminum particle. Also when the thickness (Z) is larger than 30 nm, the metallic gloss tends to be decreased.

The aluminum pigment is preferably made of aluminum or an aluminum alloy, from the viewpoints of cost performance and ensuring metallic gloss. When an aluminum alloy is used, examples of a metallic element or a nonmetallic element that is added to the alloy, other than aluminum, include silver, gold, platinum, nickel, chromium, tin, zinc, indium, titanium, and copper.

(3) Then, a glycidyl group-containing compound represented by the formula (1) is added to the aluminum pigment dispersion, followed by stirring. By doing so, hydrolysis occurs between the hydroxyl group present on the surface of the aluminum pigment and the alkoxyl group of the glycidyl group-containing compound represented by the formula (1) to form a covering layer on the surface of the aluminum pigment.

The glycidyl group-containing compound represented by the formula (1) not only can impart water repellency to the aluminum pigment but also can enhance water dispersibility due to the hydrophilicity of the ether bond of the glycidyl group on the end.

Furthermore, the glycidyl group-containing compound represented by the formula (1) is preferably a compound represented by the following formula (3):

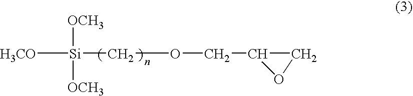

(in the formula, n is an integer of 2 to 10).

The reaction temperature for the hydrolysis reaction is preferably 10 to 90° C. and more preferably 20 to 70° C. When the temperature is lower than 10° C., the hydrolysis rate is slow, which tends to make the formation of the covering layer on the surface of the aluminum pigment insufficient. When the temperature is higher than 90° C., it is necessary to pay particular attention from the standpoint of safety.

The reaction time for the hydrolysis reaction is preferably 0.5 to 100 hours and more preferably 1 to 80 hours. When the reaction time is shorter than 0.5 hours, the hydrolysis reaction may not be thoroughly completed, resulting in insufficient water repellency and water dispersibility. When the reaction time is longer than 100 hours, the aluminum pigment may aggregate.

The addition amount of the glycidyl group-containing compound represented by the formula (1) may be determined by calculating an amount (hereinafter referred to as “1 equivalent”) that gives a thickness of 0.5 to 10 nm, preferably, 5 nm to the covering layer. When the thickness of the aluminum pigment after the hydrolysis reaction is larger than 30 nm, the metallic gloss may be decreased. Specifically, the glycidyl group-containing compound represented by the formula (1) is added in an amount of preferably 1.0 to 3.0 equivalents and more preferably 1.2 to 2.5 equivalents, based on the 1 equivalent. By adding the glycidyl group-containing compound represented by the formula (1) in a slightly excessive amount as being within the above-mentioned range, the aluminum pigment can be reliably provided with a covering layer having a desired thickness. When the addition amount of the glycidyl group-containing compound represented by the formula (1) is larger than 3.0 equivalents, unreacted glycidyl group-containing compound represented by the formula (1) may cause whitening. On the other hand, when the addition amount is smaller than 1.0 equivalent, the hydroxyl group present on the surface of the aluminum pigment may not be completely covered.

The pH of the reaction system may be any of acidic, neutral, or alkaline.

1.2 Step (b)

After the step (a), a step (b) of densifying the covering layer (hereinafter also simply referred to as “step (b)”) may be further conducted. By densifying the covering layer, water is prevented from infiltrating to the surface of the aluminum pigment. Thus, water repellency can be provided.

Examples of the method for densifying the covering layer include a method employing cationic polymerization reaction and a method by hydrothermal treatment.

In the method employing cationic polymerization reaction, a cationic polymerization initiator is added to the aluminum pigment dispersion prepared in the step (a), followed by heating. By doing so, polymerization reaction of the epoxy group on the end occurs to harden the covering layer by cross-linking. The cationic polymerization initiator is not particularly limited, and those usually used, for example, protic acid, halogenated metals, organic metal compounds, halogens, and stable carbonium ion salts, can be used.

In the method by hydrothermal treatment, the aluminum pigment dispersion prepared in the step (a) is adjusted to be basic (preferably in a pH range of 8 to 13) by adding an alkaline aqueous solution according to need and is heated. The heat treatment temperature is preferably in the range of 50 to 350° C. and more preferably 100 to 300° C.

1.3 Step (c)

After the step (a), a step (c) of adding an acidic compound for opening the glycidyl group (hereinafter also simply referred to as “step (c)”) may be conducted. By opening the glycidyl group, hydrophilicity is imparted to the aluminum pigment, and water dispersibility can be enhanced.

The acidic compound includes inorganic acids and organic acids. Examples of the inorganic acids include hydrochloric acid, nitric acid, sulfuric acid, hydrofluoric acid, and phosphoric acid. Examples of the organic acids include acetic acid, propionic acid, butanoic acid, pentanic acid, hexanoic acid, heptanoic acid, octanoic acid, nonanoic acid, decanoic acid, oxalic acid, maleic acid, arachidonic acid, oleic acid, stearic acid, linoleic acid, linolenic acid, salicylic acid, benzoic acid, benzenesulfonic acid, formic acid, malonic acid, sulfonic acid, phthalic acid, fumaric acid, citric acid, tartaric acid, maleic anhydride, itaconic acid, succinic acid, malic acid, and glutaric acid. Among them, acetic acid is preferred.

The addition amount of the acidic compound may be adjusted so that the pH is about 4 to 5. By adding the acidic compound, the glycidyl group is opened, and at the same time the alkoxysilyl group is hydrolyzed to generate a silanol group, and by adjusting the pH to about 4 to 5, the condensation reaction hardly occurs.

1.4 Step (d)

After the step (a), a step (d) of performing a reaction of the glycidyl group with alkoxysilane having an amino group and then hydrolysis reaction of the alkoxyl group of the alkoxysilane having an amino group to form a silanol group (hereinafter also simply referred to as “step (d)”) may be further conducted. By forming a silanol group by reacting the alkoxysilane having an amino group with the glycidyl group and then hydrolyzing the alkoxyl group of the alkoxysilane, the aluminum pigment is provided with hydrophilicity and the water dispersibility can be enhanced.

The alkoxysilane having an amino group is preferably a compound represented by the following formula (4):

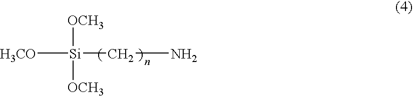

(in the formula, n is an integer of 2 to 10).

The temperature for the reaction between the glycidyl group and the alkoxysilane having an amino group may be equal to or lower than the boiling point of the compound represented by the above formula (4).

The time for the reaction between the glycidyl group and the alkoxysilane having an amino group is preferably 0.5 to 48 hours and more preferably 1 to 36 hours. When the reaction time is shorter than 0.5 hours, the reaction between the glycidyl group and the amino group may become insufficient. When the reaction time is longer than 48 hours, the aluminum pigment may aggregate.

In order to form a silanol group by hydrolyzing the alkoxyl group of the alkoxysilane, the pH may be adjusted to about 4 to 5 by adding an acidic compound. By controlling the pH to about 4 to 5, condensation reaction due to the silanol group hardly occurs. The acidic compound is not particularly limited as long as the pH can be adjusted to about 4 to 5, and examples thereof include those used in the step (c). Among them, acetic acid is preferred.

1.5 Step (e)

After the steps above, a step (e) of adding alkoxyalkylsilane for reacting the alkoxyalkylsilane with the hydroxyl group remaining on the surface of the aluminum pigment to form a covering layer on the surface of the aluminum pigment (hereinafter also simply referred to as “step (e)”) may be further conducted.

Water repellency and water dispersibility can be provided by forming a covering layer on the surface of the aluminum pigment by reacting the hydroxyl group present on the surface of the aluminum pigment with the glycidyl group-containing compound represented by the formula (1) in the step (a), but unreacted hydroxyl group may remain on the surface of the aluminum pigment. Since such unreacted hydroxyl group accelerates whitening of aluminum, the unreacted hydroxyl group remaining on the surface of the aluminum pigment is subjected to a reaction with the alkoxyl group of alkoxyalkylsilane to form a covering layer, which can further enhance the water repellency of the aluminum pigment.

The alkoxyalkylsilane is preferably a compound represented by the following formula (5).

R⁴Si(OR⁵)_{4-d} (5)

(in the formula, R⁴ and R⁵ independently represent a monovalent organic group, and d represents an integer of 1 to 3).

Preferred examples of the alkoxyalkylsilane include trimethoxymethylsilane, triethoxymethylsilane, tripropoxymethylsilane, trimethoxyethylsilane, triethoxyethylsilane, trimethoxyphenylsilane, triethoxyphenylsilane, dimethoxydimethylsilane, diethoxydimethylsilane, dimethoxydiethylsilane, diethoxydiethylsilane, dimethoxydiphenylsilane, and diethoxydiphenylsilane. Among them, trimethoxymethylsilane is particularly preferred.

The temperature of the reaction between the hydroxyl group remaining on the surface of the aluminum pigment and alkoxy group of the alkoxyalkylsilane is preferably 10 to 90° C. and more preferably 20 to 70° C. When the temperature is lower than 10° C., the reaction rate is slow, which may make the formation of the covering layer insufficient and cause whitening due to unreacted alkoxyalkylsilane. When the temperature is higher than 90° C., it is necessary to pay particular attention from the standpoint of safety.

The time for the reaction between the hydroxyl group remaining on the surface of the aluminum pigment and the alkoxy group of the alkoxyalkylsilane is preferably 0.5 to 48 hours, and more preferably 1 to 36 hours. When the reaction time is shorter than 0.5 hours, the reaction between the hydroxyl group remaining on the surface of the aluminum pigment and the alkoxy group of the alkoxyalkylsilane is insufficient, which may cause whitening due to unreacted alkoxyalkylsilane. When the reaction time is longer than 48 hours, the aluminum pigment may aggregate.

The amount of the alkoxyalkylsilane may be an amount that is sufficient for forming the covering layer to the hydroxyl group remaining on the surface of the aluminum pigment and is therefore preferably 0.1 to 0.5 equivalents and more preferably 0.1 to 0.3 equivalents based on the above-mentioned 1 equivalent. When the addition amount of the alkoxyalkylsilane is larger than 0.5 equivalents, whitening may occur due to unreacted alkoxyalkylsilane. On the other hand, when the amount is smaller than 0.1 equivalents, the hydroxyl group remaining on the surface of the aluminum pigment may not be completely covered.

1.6 Step (f)

After the steps above, a step (f) of adding a surfactant (hereinafter also simply referred to as “step (f)”) may be further conducted. By adding a surfactant, the water dispersibility of the aluminum pigment can be enhanced.

The surfactant is preferably an anionic surfactant or a nonionic surfactant, and an anionic surfactant is more preferred. By using an anionic surfactant, not only the water dispersibility of the aluminum pigment can be enhanced, but also the metallic gloss can be maintained. When an anionic surfactant is used, the anionic surfactant may be a polymer-type or phosphorous anionic surfactant. Examples of commercially available anionic surfactant include trade name “Neocol” series, phosphorous ester-type “Plysurf” series, and polymer-type “DKS Discoat KS-140”, manufactured by Dai-ichi Kogyo Seiyaku Co., Ltd. When a nonionic surfactant is used, the nonionic surfactant preferably has an HLB value of 10 or more and is preferably water-soluble. Examples of commercially available nonionic surfactant include trade name “Tween 40” (HLB value: 15.6), manufactured by Nacalai Tesque, Inc.

After the surfactant is added to the aluminum pigment dispersion, the mixture may be stirred at room temperature for about 1 to 30 hours, but in order to rapidly dissolve the surfactant, it is preferable to apply external force such as ultrasonic radiation.

The addition amount of the surfactant is preferably 0.5 to 15 parts by mass and more preferably 0.5 to 10 parts by mass based on 100 parts by mass of the aluminum pigment dispersion.

1.7 Step (g)

After the steps above, a step (g) of removing at least part of the organic solvent and then adding an aqueous solution of a phosphorous anionic surfactant for solvent substitution (hereinafter also simply referred to as “step (g)”) may be conducted. By the step (g), the organic solvent in the aluminum pigment dispersion prepared in each step above can be substituted with an aqueous solvent, and thereby an aluminum pigment dispersion excellent in water dispersibility and water repellency can be provided. Since the solvent of the aluminum pigment dispersion prepared by the step (g) is an aqueous solvent, the aluminum pigment dispersion can be easily applied to an aqueous ink composition.

First, the organic solvent is removed from the aluminum pigment dispersion by separating the organic solvent and the aluminum pigment provided with the covering layer by, for example, filtration, centrifugal sedimentation, or centrifugation. The operation of centrifugation is simple and is therefore preferably used for removing the organic solvent. These methods preferably remove at least 70% of the solvent contained in the aluminum pigment dispersion.

Then, an aqueous solution of a phosphorous anionic surfactant is added in the same amount as that of the removed organic solvent, followed by stirring. Here, the solvent used for the solvent substitution is preferably an aqueous solution of a phosphorous anionic surfactant from the viewpoints of ensuring water dispersibility and water repellency of the aluminum pigment. An aqueous solution of a phosphate ester-type anionic surfactant is further preferably used. Examples of commercially available phosphate ester-type anionic surfactant include trade name “Plysurf” series, manufactured by Dai-ichi Kogyo Seiyaku Co., Ltd.

For example, the water dipersibility of the aluminum pigment can be enhanced even by using an aqueous solution of an anionic surfactant other than the phosphorous anionic surfactant or a nonionic surfactant, but the water repellency is insufficient. Therefore, hydrogen gas is generated with passage of time, resulting in a tendency of losing the metallic gloss of the aluminum pigment. The use of the phosphorous anionic surfactant can enhance the water dispersibility of the aluminum pigment and also can enhance the water repellency.

The concentration of the aqueous solution of the phosphorous anionic surfactant is preferably 0.05 to 10% by mass and more preferably 0.5 to 5% by mass. The concentration in the range above is sufficient for enhancing the water dispersibility and water repellency of the aluminum pigment.

### 2. Water-Repellent Treated Aluminum Pigment

The water-repellent treated aluminum pigment according to the embodiment is obtained through the above-described production process. In the water-repellent treated aluminum pigment, a covering layer containing at least Si is formed on the surface of an aluminum pigment having an average thickness of 5 to 30 nm and a 50% mean particle diameter of 0.5 to 3 μm. When the aluminum pigment has an average thickness of 5 to 30 nm, the water-repellent treated aluminum pigment can have excellent metallic gloss. When the average thickness is smaller than 5 nm, the metallic gloss tends to decrease, and also when the average is larger than 30 nm, the metallic gloss tends to decrease.

The thickness of the covering layer is preferably 0.5 to 10 nm and more preferably 1 to 9 nm. When the thickness of the covering layer is smaller than 0.5 nm, the water repellency and the water dispersibility of the aluminum pigment are insufficient. On the other hand, the thickness of the covering layer is larger than 10 nm, the metallic gloss tends to be decreased though water repellency and water dispersibility are imparted to the aluminum pigment.

The aluminum pigment surface coverage ratio by the covering layer is calculated from the composition ratios of C, O, Al, and Si elements that are detected by an X-ray photoemission spectroscope (hereinafter also referred to as “XPS”) at an X-ray irradiation angle of 30°. When the X-ray irradiation angle is θ, since measurement depth is proportional to sin θ, it is thought that a larger amount of surface information can be obtained by decreasing as much as possible the irradiation angle of the X-ray. Accordingly, the X-ray irradiation angle is determined to be 30°.

A method for determining the aluminum pigment surface coverage ratio by the covering layer, which is based on the composition ratios of C, O, Al, and Si elements measured with an XPS at an X-ray irradiation angle of 30°, will be described below.

The composition ratios of C, O, Al, and Si elements obtained from XPS measurement are imputed to the following.

(1) Al

The composition ratio of Al is imputed to simple Al (Al) not bonded to oxygen and Al (Al₀) bonded to oxygen. The ratio of the simple Al (Al) not bonded to oxygen and the Al (Al₀) bonded to oxygen can be determined by separating peaks of an Al-2p spectrum and based on the area ratio of the peaks.

(2) Si

The composition ratio of Si is imputed to Si (Si₁) derived from the glycidyl group-containing compound represented by the formula (1) and Si (Si₂) derived from alkoxyalkylsilane when the alkoxyalkylsilane is added.

(3) O

The composition ratio of O is imputed to O (O₀) boned to Al, O (O₁) derived from the glycidyl group-containing compound represented by the formula (1), and O (O₂) derived from alkoxyalkylsilane when the alkoxyalkylsilane is added.

(4) C

The composition ratio of C is imputed to C (C₁) derived from the glycidyl group-containing compound represented by the formula (1) and C (C₂) derived from alkoxyalkylsilane when the alkoxyalkylsilane is added.

Based on the above-mentioned element imputation, the aluminum pigment surface coverage ratio by the covering layer can be determined by the following expression (6):

Coverage ratio (%)=[{(Si₁+O₁+C₁)+(Si₂+O₂+C₂)}/{(Si₁+O₁+C₁)+(Si₂+O₂+C₂)+Al+(Al₀+O₀)}]×100

The coverage ratio of the water-repellent treated aluminum pigment according to the embodiment by the covering layer, calculated by the expression (6), is from 20 to 90% and more preferably 30 to 60%. When the coverage ratio is within such a range, water repellency can be imparted to the aluminum pigment, and thereby whitening does not occur even when the pigment is dispersed in water. When the coverage ratio is smaller than 20%, the aluminum pigment may whitens due to insufficient water repellency and also may aggregate to cause blackening due to insufficient water dispersibility. On the other hand, when the coverage ratio is larger than 90%, it involves technical difficulty.

### 3. Aqueous Ink Composition

The aqueous ink composition according to the embodiment contains an aluminum pigment dispersion produced by the above-described method for producing water-repellent treated aluminum pigment dispersion. In the specification, the term “aqueous ink composition” refers to an ink composition containing 70% by mass or more of water as a solvent. The water is preferably pure water or ultrapure water such as ion-exchanged water, ultrafiltered water, reverse osmosis water, or distilled water. In particular, water in which the above-mentioned water is sterilized by, for example, ultraviolet irradiation or hydrogen peroxide addition can be prevented from occurrence of molds or bacteria for a long period of time and therefore is preferred.

The concentration of the aluminum pigment in the aqueous ink composition according to the embodiment is preferably 0.1 to 3.0% by mass, more preferably 0.25 to 2.5% by mass, and most preferably 0.5 to 2.0% by mass based on the total mass of the aqueous ink composition.

The aqueous ink composition according to the embodiment may further contain, for example, an organic solvent, a resin, a surfactant, a polyol, an antioxidant, an ultraviolet absorber, or a pH adjuster, according to need.

The aqueous ink composition according to the embodiment preferably has a viscosity of 2 to 10 mPa·s and more preferably 3 to 5 mPa·s at 20° C. When the aqueous ink composition has a viscosity within the above-mentioned range at 20° C., the composition can be further suitably applied to an ink jet recording apparatus, an appropriate amount of the composition can be discharged from a nozzle, and curved flying and scattering of the composition can be further reduced.

### 4. Examples

### 4.1 Example 1

A resin layer coating liquid composed of 3.0% by mass of cellulose acetate butyrate (degree of butylation: 35 to 39%, manufactured by Kanto Chemical Co., Inc.) and 97% by mass of diethylene glycol diethyl ether (manufactured by Nippon Nyukazai Co., Ltd.) was uniformly applied onto a PET film having a thickness of 100 μm by bar coating, followed by drying at 60° C. for 10 minutes to form a resin layer thin film on the PET film.

Then, an aluminum deposition layer having an average thickness of 20 nm was formed on the resin layer using a vacuum deposition apparatus (“VE-1010 vacuum deposition apparatus”, manufactured by Vacuum Device Inc.).

Then, the laminate formed by the above-described method was simultaneously peeled, pulverized so as to be reduced in size, and dispersed in diethylene glycol diethyl ether using an ultrasonic disperser model VS-150 (manufactured by As One Corp.) to prepare an aluminum pigment dispersion that has been subjected to ultrasonic dispersion treatment for 12 hours in total.

The resulting aluminum pigment dispersion was filtered through an SUS mesh filter with a pore size of 5 to remove coarse particles. Then, the filtrate was put in a round-bottomed flask, and diethylene glycol diethyl ether was distilled off using a rotary evaporator. By doing so, the aluminum pigment dispersion was concentrated, and then the concentration of the aluminum pigment in the dispersion was adjusted to 5% by mass to obtain an aluminum pigment dispersion A.

Then, 100 g of the resulting aluminum pigment dispersion A was put in a beaker, and 14.34 g of γ-glycidoxypropyltrimethoxysilane (trade name “A-187”, manufactured by Nippon Unicar Co., Ltd.) was added in the beaker, followed by stirring at room temperature for 3 days for hydrolysis reaction. By doing so, an aluminum pigment dispersion B in which a covering layer was formed on the surface of the aluminum pigment was prepared.

Then, the resulting aluminum pigment dispersion B was transferred to a round-bottomed flask, and a cationic polymerization initiator (trade name “San-Aid SI-L”, manufactured by Sanshin Chemical Industry Co., Ltd.) was added thereto in a concentration of 1% by mass, followed by stirring at 100° C. for 5 hours for polymerization reaction. By doing so, an aluminum pigment dispersion C in which the covering layer formed on the surface of the aluminum pigment was densified was obtained.

### 4.2 Example 2

First, an aluminum pigment dispersion B was prepared as in “4.1 Example 1”.

Then, 100 g of the aluminum pigment dispersion B was put in a beaker, and an aqueous solution of an acetic acid was added thereto with stirring for opening the glycidyl group to provide hydrophilicity. Thus, an aluminum pigment dispersion D was obtained.

### 4.3 Example 3

First, an aluminum pigment dispersion B was prepared as in “4.1 Example 1”.

Then, 100 g of the aluminum pigment dispersion B was put in a beaker, and 12.00 g of γ-aminopropyltrimethoxysilane (trade name “A-1100”, manufactured by Nippon Unicar Co., Ltd.) was added thereto with stirring, followed by stirring at room temperature for 1 day for reacting the γ-aminopropyltrimethoxysilane with the glycidyl group.

Then, the resulting product was put in a beaker, and the pH thereof was adjusted to 4 by adding an aqueous solution of an acetic acid with stirring to hydrolyze the methoxy group for silanolization.

Then, the solvent was removed by centrifugation (10000 rpm), and an acetic acid aqueous solution with a pH of 4 was added in the same amount as that of the removed solvent to obtain an aluminum pigment dispersion E.

### 4.4 Example 4

First, an aluminum pigment dispersion B was prepared as in “4.1 Example 1”.

Then, 100 g of the aluminum pigment dispersion B was put in a beaker, and 5.91 g of trimethoxymethylsilane (manufactured by Tokyo Chemical Industry Co., Ltd.) was added thereto with stirring, followed by stirring at room temperature for 1 day. By doing so, an aluminum pigment dispersion F in which the hydroxyl group remaining on the surface of the aluminum pigment was capping-treated was obtained.

### 4.5 Example 5

First, an aluminum pigment dispersion F was prepared as in “4.4 Example 4”.

Then, the aluminum pigment dispersion F was put in a beaker, and a phosphate ester-type anionic surfactant (trade name “Plysurf M-208B”, manufactured by Dai-ichi Kogyo Seiyaku Co., Ltd.) was added in an amount of 1 part by mass based on 100 parts by mass of the aluminum pigment dispersion F, followed by stirring for 3 minutes with ultrasound irradiation.

Then, the resulting product was subjected to centrifugation (12000 rpm, 60 minutes) for removing the solvent in an amount corresponding to 70% by mass. Then, a 1% by mass aqueous solution of a phosphate ester-type anionic surfactant (trade name “Plysurf M-208B”, manufactured by Dai-ichi Kogyo Seiyaku Co., Ltd.) was added with stirring in the same amount as that of the removed solvent. Thus, an aluminum pigment dispersion G was obtained.

### 4.6 Comparative Example 1

First, an aluminum pigment dispersion A in an concentration of 51 by mass was prepared as in “4.1 Example 1”.

Then, 100 g of the aluminum pigment dispersion A was put in a beaker, and 12.00 g of γ-aminopropyltrimethoxysilane (trade name “A-1100”, manufactured by Nippon Unicar Co., Ltd.) was added thereto with stirring, followed by stirring at room temperature for 3 days for hydrolysis reaction. By doing so, a covering layer was formed on the surface of the aluminum pigment. Thus, an aluminum pigment dispersion H was obtained.

### 4.7 Comparative Example 2

First, an aluminum pigment dispersion A in a concentration of 51 by mass was prepared as in “4.1 Example 1”.

Then, 100 g of the resulting aluminum pigment dispersion A was put in a beaker, and 5.91 g of trimethoxymethylsilane (manufactured by Tokyo Chemical Industry Co., Ltd.) was added thereto, followed by stirring at room temperature for 1 day. By doing so, an aluminum pigment dispersion I in which the hydroxyl group present on the surface of the aluminum pigment was capping-treated was obtained.

### 4.8 Comparative Example 3

The aluminum pigment dispersion A prepared in “4.1 Example 1” was used as reference.

### 4.9 Evaluation Test

4.9.1 Water Repellency Evaluation Test

Water (2 mL) was put in a sample bottle, and one drop of any of the resulting aluminum pigment dispersions A to I was added in the bottle, followed by being left standing at a constant temperature of 25° C. The water repellency of the aluminum pigment dispersion was evaluated by visually observing changes with the passage of time. The evaluation criteria of water repellency of the aluminum pigment dispersion are as follows:

Excellent: no change was observed and silver flake-like shape was maintained even after 6 months;

Good: whitening was slightly observed at the time after 10 days;

Fair: whitening was observed at the time after 3 days; and

Poor: whitening was observed at the time after 1 day.

4.9.2 Dispersibility Evaluation Test

Water (2 mL) was put in a sample bottle, and one drop of any of the resulting aluminum pigment dispersions A to I was added in the bottle, followed by being left standing at a constant temperature of 25° C. The dispersibility of the aluminum pigment dispersion was evaluated by visually observing changes with the passage of time. The evaluation criteria of dispersibility of the aluminum pigment dispersion are as follows:

Excellent: no change was observed and silver flake-like shape was maintained even after 6 months;

Good: aggregation was observed at the time after 10 days;

Fair: aggregation was observed at the time after 3 days; and

Poor: coarse dispersion or layer separation occurred immediate after the addition.

4.9.3 Gloss Evaluation Test

Any of the aluminum pigment dispersions A to I prepared by the above-described processes was dropwise applied to a printing paper (“PM photograph (glossy) model No. KA450PSK”, manufactured by Seiko Epson Corp.), followed by drying at room temperature for 1 day. The printability of the aluminum pigment was evaluated by observing the resulting sample visually and with a scanning electron microscopy. The evaluation criteria of printability of the aluminum pigment are as follows:

Excellent: sample was excellent in metallic gloss, and specular gloss was observed;

Good: sample was excellent in metallic gloss, but was slightly mat;

Fair: sample was mat; and

Poor: whitening or blackening was observed.

4.9.4 Evaluation Result

Table 1 shows the results of the water repellency, dispersibility, and gloss evaluation tests of the aluminum pigment dispersions A to I prepared in the above-described processes.

TABLE 1

| | | | | | | | Comparative | Comparative | Comparative |
|---|---|---|---|---|---|---|---|---|---|
| | | Example 1 | Example 2 | Example 3 | Example 4 | Example 5 | Example 1 | Example 2 | Example 3 |
| Type of aluminum pigment | | C | D | E | F | G | H | I | A |
| dispersion | | | | | | | | | |
| Evaluation | Water-repellency | Excellent | Fair | Fair | Good | Good | Poor | Poor | Fair |
| results | evaluation | | | | | | | | |
| | test | | | | | | | | |
| | Dispersibility | Fair | Fair | Good | Fair | Excellent | Poor | Poor | Poor |
| | evaluation | | | | | | | | |
| | test | | | | | | | | |
| | Gloss evaluation | Excellent | Fair | Good | Good | Good | Poor | Poor | Poor |
| | test | | | | | | | | |

From Table 1, it was confirmed that the aluminum pigment dispersion C of Example 1 was notably excellent in metallic gloss and had water repellency even after 6 months. The observation of the samples prepared in the gloss evaluation test with an SEM confirmed regular stacking of the aluminum thin flakes. However, occurrence of slight aggregation was confirmed at the time after 3 days, and therefore there was room for improvement in dispersibility.

In the aluminum pigment dispersion D of Example 2, hydrophilization was tried by opening the glycidyl group, but no improvement in dispersibility was observed even if compared to the aluminum pigment dispersion C that was not subjected to the ring opening. In addition, the metallic gloss was decreased due to aggregation.

The aluminum pigment dispersion E of Example 3 was provided with excellent water dispersibility by silanolizing the methoxy group, but whitening was observed after 3 days to show insufficient water repellency. In addition, the gloss evaluation confirmed that the sample had metallic gloss, but was slightly mat.

In the aluminum pigment dispersion F of Example 4, the hydroxyl group remaining on the surface of the aluminum pigment in the aluminum pigment dispersion B was covered with trimethoxymethylsilane. The water repellency was satisfactory, but aggregation was observed at the time after 3 days.

The aluminum pigment dispersion G of Example 5 was satisfactory in all of water repellency, dispersibility, and gloss and was the most well-balanced aluminum pigment dispersion.

On the other hand, in the aluminum pigment dispersion H according to Comparative Example 1, the hydroxyl group present on the surface of the aluminum pigment was reacted with alkoxysilane having an amino group. The evaluation results in all the water repellency, dispersibility, and gloss were not satisfactory. It is suggested that since the amine system is basic, whitening of the aluminum pigment tends to occur. In addition, the observation of the sample prepared in the gloss evaluation test with an SEM confirmed that aluminum thin flakes were partially aggregated.

In the aluminum pigment dispersion I of Comparative Example 2, the hydroxyl group present on the surface of the aluminum pigment was covered with trimethoxymethylsilane only. The evaluation results were not satisfactory in all of the water repellency, dispersibility, and gloss.

It was confirmed from the results above that the aluminum pigment dispersions of Examples 1 to 5 were improved in all evaluation items of the water repellency, dispersibility, and gloss compared to the aluminum pigment dispersion A used as reference.

What is claimed is:

1. A method for producing water-repellent treated aluminum pigment dispersion comprising:
(a) adding a glycidyl group-containing compound represented by the following formula (1) to an aluminum pigment dispersion in which an aluminum pigment is dispersed in an organic solvent for reacting a hydroxyl group present on the surface of the aluminum pigment with the glycidyl group-containing compound represented by the formula (1) to form a covering layer on the surface of the aluminum pigment: 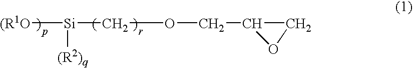
(in the formula, p represents an integer of 1 to 3, q represents an integer that satisfies a relation of p+q=3, r is an integer of 2 to 10, and R¹ and R² independently represent an alkyl group having 1 to 4 carbon atoms).

2. The method for producing water-repellent treated aluminum pigment dispersion according to claim 1, the method further comprising:
(b) densifying the covering layer, after the (a).

3. The method for producing water-repellent treated aluminum pigment dispersion according to claim 1, the method further comprising:
(c) adding an acid for opening the glycidyl group, after the (a).

4. The method for producing water-repellent treated aluminum pigment dispersion according to claim 1, the method further comprising:
(d) subjecting the glycidyl group to a reaction with alkoxysilane having an amino group and then hydrolyzing the alkoxyl group of the alkoxysilane having an amino group to form a silanol group, after the (a).

5. The method for producing water-repellent treated aluminum pigment dispersion according to claim 1, the method further comprising:
(e) adding alkoxyalkylsilane for a reaction of the hydroxyl group remaining on the surface of the aluminum pigment with the alkoxyalkylsilane to form a covering layer on the surface of the aluminum pigment, after the (a).

6. The method for producing water-repellent treated aluminum pigment dispersion according to claim 5, wherein
the alkoxyalkylsilane is trimethoxymethylsilane.

7. The method for producing water-repellent treated aluminum pigment dispersion according to claim 1, the method further comprising:
(f) adding a surfactant, after the (a).

8. The method for producing water-repellent treated aluminum pigment dispersion according to claim 7, wherein
the surfactant is an anionic surfactant.

9. The method for producing water-repellent treated aluminum pigment dispersion according to claim 1, the method further comprising:
(g) removing at least part of the organic solvent and then adding an aqueous solution of a phosphorous anionic surfactant for solvent substitution, after the (a).

10. The method for producing water-repellent treated aluminum pigment dispersion according to claim 1, wherein
the aluminum pigment is a plate-like particle having an average thickness of 5 to 30 nm and a 50% mean particle diameter of 0.5 to 3 μm.

11. The method for producing water-repellent treated aluminum pigment dispersion according to claim 1, wherein
the covering layer has a thickness of 0.5 to 10 nm.

12. The method for producing water-repellent treated aluminum pigment dispersion according to claim 1, wherein
the organic solvent is diethylene glycol diethyl ether or triethylene glycol monobutyl ether.

13. An aqueous ink composition containing a water-repellent treated aluminum pigment dispersion produced by the method for producing water-repellent treated aluminum pigment dispersion according to claim 1.

14. A water-repellent treated aluminum pigment in which a covering layer containing at least Si is formed on the surface of an aluminum pigment having an average thickness of 5 to 30 nm and a 50% mean particle diameter of 0.5 to 3 μm, wherein
the coverage ratio of the aluminum pigment surface by the covering layer is from 20 to 90% when it is calculated from the composition ratios of C, O, Al, and Si that are detected by XPS measurement at an incident angle of 30°.

15. The water-repellent treated aluminum pigment according to claim 14, wherein
the covering layer has a thickness of 0.5 to 10 nm.
